(19) United States
(12) Patent Application Publication
(10) Pub. No.: US 2004/0059628 A1
(43) Pub. Date: Mar. 25, 2004

(54) Service assessment system

(76) Inventors: Stephen Parker, Yarmouth (GB); Christopher Darvell, Bagshot (GB); Malcolm Darvell, Upper Bucklebury (GB)

Correspondence Address: Eitan, Pearl, Latzer & Cohen Zedek, LLP, Suite 1001, 10 Rockefeller Plaza, New York, NY, 10020, US

(21) Appl. No.: 10/444,493

(22) Filed: May 23, 2003

(30) Foreign Application Priority Data
May 27, 2002 (GB) 0212184.6

(51) Int. Cl. G06F 17/60

(52) U.S. Cl. 705/12

(57) ABSTRACT

A computer-implemented method of processing data for evaluating service providers is disclosed. The method comprises providing a qualitative rating scale for each of a number of service actions performed by the service providers; receiving data from a user in the form of subjective scores on the rating scale for each service action and for each service provider; processing the data to compare ratings scores for service actions of a specific service provider with ratings scores of other service providers for those service actions; and collating the ratings score comparisons to provide an evaluation of the specific service provider's comparative performance. In preferred examples, the method is implemented in the form of web-based software. Aspects of the invention are applicable, for example, to the assessment of equity brokers by traders using their services, and to similar business relationships.

### BACKGROUND OF THE INVENTION

This invention is directed to the provision of a system of appraisal of a service by users of the service and by companies providing the service. In particular applications, the invention is directed to the assessment by a customer of the performance of a number of service providers. In a more particular example, the invention is directed to the assessment of equity brokers by traders using their services.

A wide variety of professional services are provided by many companies to an equally wide range of customers. Typically, customers will employ some form of assessment of the service provider, in order to determine whether the service represents value for money. Similarly, the service providers will employ some system for assessing the requirements of the users.

However, in many service areas, such assessment is difficult, time consuming and expensive to achieve. Furthermore, an individual's opinion of a service it is being provided may be uniquely flawed.

### BRIEF SUMMARY OF THE INVENTION

It is therefore an object of the invention to address these problems, and to provide an improved system for the assessment of professional services.

Accordingly, the invention consists in one aspect in a computer-implemented method of processing data for evaluating service providers, comprising the steps of providing a qualitative rating scale for each of a plurality of service actions performed by the service providers, receiving data from a user in the form of subjective scores on the rating scale for each service action, for each service provider, processing the data to compare ratings scores for service actions of a specific service provider with ratings scores of other service providers for those service actions, and collating the ratings score comparisons to provide an evaluation of the specific service provider's comparative performance.

In another aspect, the invention consists in a collaborative computer-implemented method of processing data for evaluating service providers, comprising the steps of providing to each of a group of users a common qualitative rating scale for each of a plurality of service actions performed by the service providers, receiving data from each user in the form of subjective scores on the rating scale for each service action, for each service provider, processing the data to compare ratings scores for service actions of a specific service provider with ratings scores of other service providers for those service actions, collating the ratings score comparisons to provide an evaluation of the specific service provider's comparative performance, and providing a representation of such evaluation to each user.

In a further aspect, the invention provides a computer-implemented method of processing data for assessing the requirements of a specific user for a service to be provided, comprising the steps of providing a qualitative rating scale for each of a plurality of service actions provided, receiving data from a plurality of independent users in the form of independently subjective scores on the rating scale for each service action, processing the data to compare the distribution of ratings scores over the plurality of service actions from the specific user with the distribution of scores over the service actions from other users, and recording those service actions for which for the specific user the distribution varies significantly relative to the distribution for other users.

In still another aspect, the invention consists in a data processing system for providing performance evaluation of a plurality of service providers to a plurality of service users, comprising, in a service user domain, data processing sites for each of the plurality of service users, and means for providing a qualitative rating scale for each of a plurality of service actions performed by the service providers, to each of the plurality of service users' processing sites, a central server for receiving data from user sites in the form of subjective scores on the rating scale for each service action and for each service provider, processing the data to compare ratings scores for service providers, and collating the ratings score comparisons to provide evaluation of the service providers' comparative performance; and means for communication of data between the central server and the user domain.

In a further aspect, the invention provides a data processing system for providing performance evaluation of a plurality of service providers, comprising: a service weighting interface providing a hierarchy of service actions to be performed by the service providers in a plurality of service categories and enabling entry by a user of relative weighting values for service actions in each service category and for each category; a service weighting display serving to display a normalized representation of said user entered weighting values indicating the apportionment of given resource between service categories in accordance with said user entered weighting values; a service assessment interface providing a hierarchy of service actions to be performed by the service providers in a plurality of service categories and enabling entry by a user of subjective scores on the rating scale for each service action and for each service provider; a processor for receiving data in the form of subjective scores on the rating scale for each service action and for each service provider, applying said weightings to said data, and processing the weighted data to compare ratings scores for service providers; and a service provider assessment display indicating comparative ratings scores for respective service providers according to respective service categories.

### BRIEF DESCRIPTION OF THE DRAWINGS

The invention will now be described by way of example with reference to the accompanying drawings, in which:

FIG. 1 is a diagram illustrating a system according to an embodiment of the invention; and

FIGS. 2 to 8 are diagrams illustrating data processing and display techniques according to embodiments of the invention.

### DETAILED DESCRIPTION OF THE INVENTION

In the following description, the example used is that of a system for providing assessment of equity brokers for the use of fund management groups, and also for feedback to the brokers themselves. It will be understood by the skilled reader that the invention is not restricted to the particular embodiments described, and indeed, may be applied to a wide variety of service assessment scenarios.

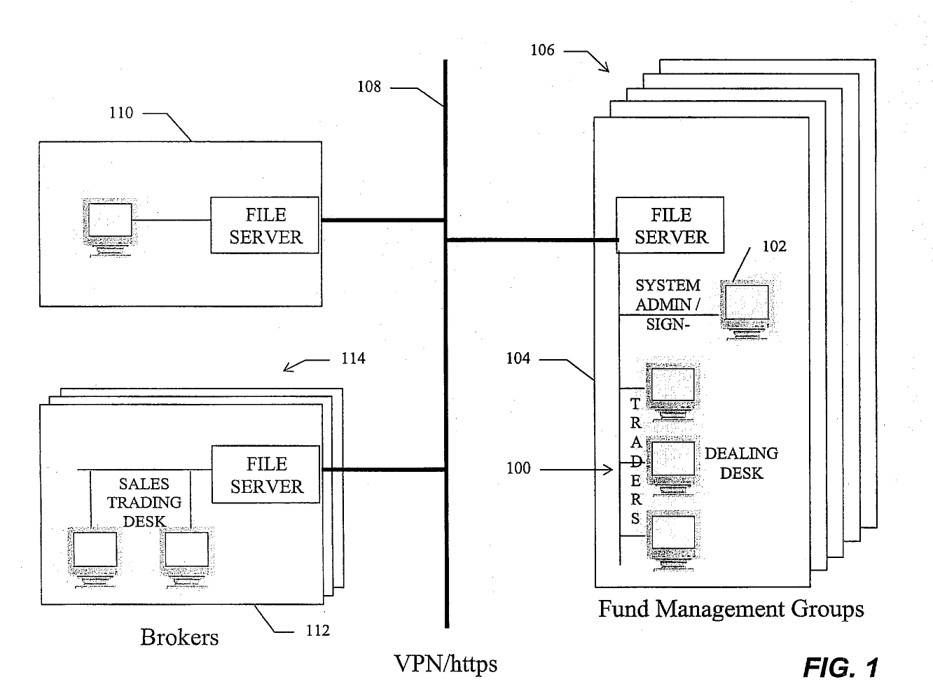

Taking the example of equity broker assessment, typically, within a Fund Management Group (FMG), groups of traders conduct transactions on behalf of the FMG through brokers, who perform the actual equity purchase or sale. Assessment of the performance of those brokers in various aspects of their transacting services may be performed as shown in FIG. 1, which illustrates an overview of a system according to an embodiment of the invention.

Traders (100) occupy positions at an FMG (104), one of a number of similar FMGs (106). In an assessment, the traders (100) rate their broker (112), one of a number of broker houses (114), on performance of various services. The ratings from this particular FMG (104) are passed across a network (108) to a central server (110). The network may comprise a public network such as the internet, in which case suitable methods of protecting the information may be employed, such as SSL or a Virtual Private Network. At the central server (110), the ratings data are collated, aggregated and/or weighted as appropriate (as described in greater detail below). Through the approval of a system administrator (102), this collated data is then available to the brokers (114), and also to the FMGs (106).

From this point, various analyses of the data may be performed. At the FMG (104) end, the pure in-house data may simply be used by itself, but will likely be more illustrative in comparison with the data from other FMGs. The data may be manipulated in various illuminating ways, for example, it may be compared with historic data, weighted according to various parameters, recorded to comply with certain industry standard criteria or analyzed on a trader-by-trader basis.

At the broker (112) end, the data for a single FMG might be analyzed, in order to illustrate that firm's particular requirements. The data from the FMG in question may be compared with its peers, in order to give a different picture of its particular requirements, or the entire group of FMGs may be analyzed in order to assess general trends in, for example, the broker's performance, or the FMG market's changing needs.

The brokers (114) are also provided with a similar system for rating their relationships with the FMGs (106). This can be used in similar fashion by either side, in order to improve the running of business transactions between the two.

In other embodiments, different system architectures may be used. For example, some collation, weighting and aggregation of data may be carried out locally at the FMG (104), for example at the system administration terminal (102), with the local data being available directly to the FMG for analysis. The local data may then be forwarded, for example in aggregated form, to the central server (110) for further processing.

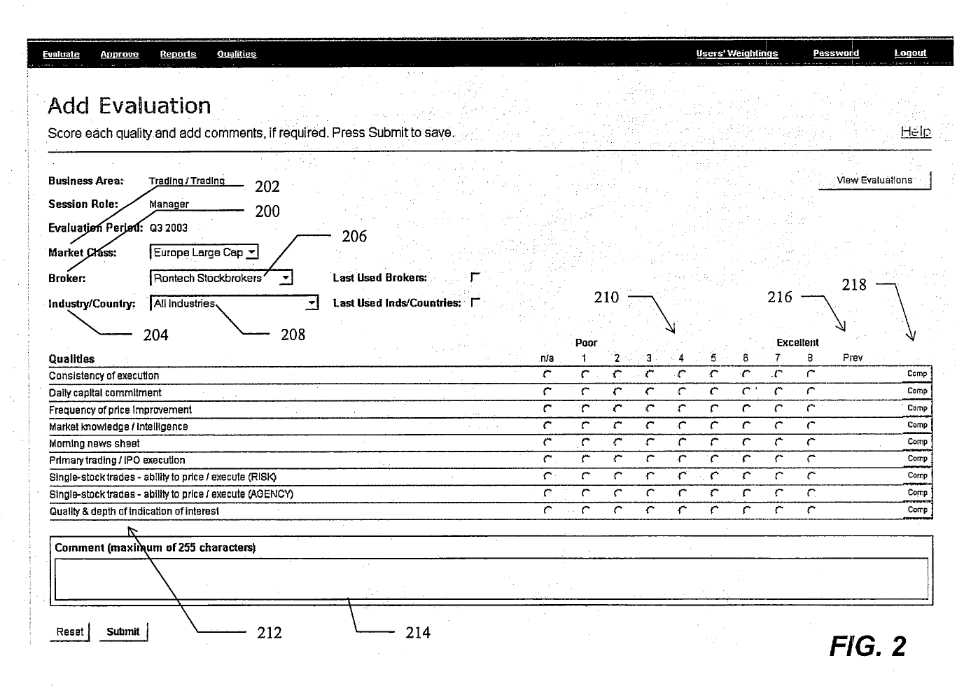

Keeping with the example of FMGs and brokers, the detailed functionality of a system according to a particular embodiment will now be described with reference to FIGS. 2 to 8.

The system is typically implemented in a computer software package; in the embodiment described below, the software is web-based, typically running Java applets. In embodiments, the software may be customized to add or remove any of the features described, or to modify their parameters.

In its evaluation function at the FMG end, as shown in the example user interface screen of FIG. 2, a user at a trading desk (100) is required to choose a broker (200) to assess, and a market (202) and, where necessary, an industry sector or country (204) to assess it under. Data is then entered into the system under a chosen broker (206) and, as applicable, a chosen industry sector or country (208) as a series of ratings (210) of various qualities (212). The qualities typically relate to the broker's performance of various service actions or to general service quality indicators. In this example, the qualities (212) rated, such as consistency of execution and frequency of price improvement, are shown in FIG. 2. These qualities are rated (210), in this example on a scale of 1 to 8. Such a scale lends two advantages: the data may be divided simply into quartiles, for ease of analysis; and the user is prevented from choosing a “middle option” in rating a quality, thus, ideally, promoting a greater depth of thought in producing the rating. To provide context, the ratings entered by the user for the previous quarter are displayed in a column (216) next to the ratings (210) if available. Furthermore, by clicking on one of the comparison buttons (218) in the last column, the user may view a comparison of the ratings given by the user to other brokers for the same quality. In this way, the user may be able to provide more meaningful ratings. Furthermore, the user may enter a text comment (214), for example, to highlight particular problems experienced with the broker in question.

Evaluation at the FMG end may thus follow these steps for all brokers (114), evaluated by each trader at the dealing desk (100) of each of the Fund Management Groups (106), thereby creating a large pool of ratings data. In a particular FMG, it may of course be stipulated that only certain qualities are rated, or that particular firms are rated.

In one embodiment, ratings from differently experienced employees are given different weightings. For example, a senior trader's ratings scores may be given five times the weight of a rookie trader. These weightings may contribute to the pool of data forwarded to the central server (110), or to the in-house server (102), or may simply be used in the local analysis of the data entered.

The user interface screen also provides a number of links and buttons to perform functions such as submitting the ratings data entered and accessing other screens of the system, for example to define weightings or perform analyses and produce reports.

In one embodiment, ratings provided by individual users of the system are not included in the pool of data used by the analysis functions of the system until they have been approved by a user having appropriate authority, for example a senior trader/supervisor. In this embodiment, interface screens are provided allowing the supervisor to view, amend and approve a given user's ratings. After amending ratings, the supervisor can immediately display a broker's weighted average scores in the given industry sector to determine the effect of the amendment. To ensure that the amendment feature is not used inappropriately, a report detailing rating amendments carried out by supervisors may be generated. For approved ratings, a supervisor may also view which user approved the ratings and may “unapprove” them (i.e. undo the previous approval). Only approved ratings are used during analysis of the ratings data.

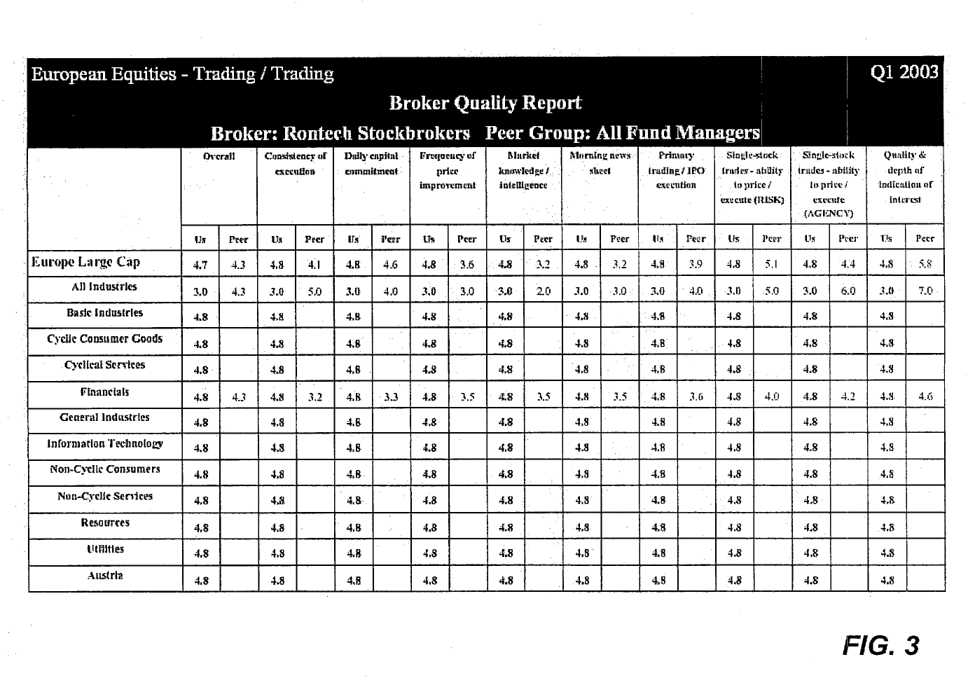

In the FMGs' analysis function, as shown for example in FIG. 3, the data available may be that of the single trader, dealing desk (100), or FMG (104), or may draw on the data pool from every FMG (106).

Initially, in this embodiment, the user is required to choose either a broker (200), market (202) or sector (204) to analyze. This provides various angles of analysis: for example, if a broker is chosen, the market and sector performance of that particular broker may be analyzed; if a sector is chosen, the performance of brokers in that sector, by market may be assessed.

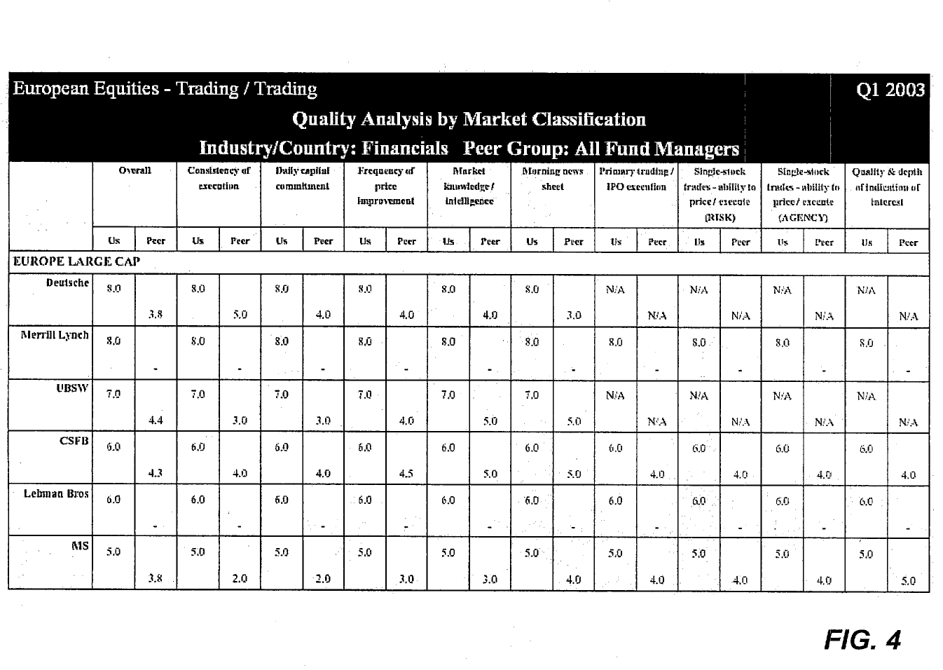

In the example shown in FIG. 3, the user has chosen to display the average ratings given by their firm for a particular broker under each assessed quality across various industry sectors and countries. The results could alternatively be presented in the form of a chart, for example a three-dimensional bar chart. In FIG. 4, a further example report shows the average ratings given to a range of brokers in the “Financials” industry sector. The ratings shown are for illustrative purposes only. In both examples, the average ratings of a selected peer group (in this case, all other fund managers) are also shown (in the “Peer” columns) to enable comparison. The peer group used for comparison may be selected by the user from a selection of pre-defined peer groups. This enables a user to choose a peer group which will provide a meaningful comparison. This may be especially important where different Fund Management Groups use very different weightings for the different business (sub-)areas and industry sectors, which could potentially distort the comparison. Providing pre-defined peer groups prevents the user from being able to view the scores of a particular Fund Management Group. However, a system in which the user can freely select a relevant peer group could also be provided.

Similar tables or charts could show the ratings of different FMGs, or the ratings averaged over a number of FMGs given to a broker, or set of brokers. Similarly, the results could be analyzed by any combination of, or average over, individual traders, sectors or markets.

In one embodiment, the ratings are weighted differently from one sector, or market, to the next, depending on the importance attached to that sector or market by the particular FMG. This is described in more detail below.

The results displayed may then be compared to the business given to each broker, for example, by trading volume, giving a simple measure for a particular FMG, for instance, of whether business allocated to brokers correlates to the quality of the services they provide. The results may also be compared to other FMG's results in order to determine, for example, whether brokers not currently used are worth employing, or how other FMGs might be making better use of particular broker houses' services. The ratings may also be compared with historical data, giving a clearer indication of trends in business allocation and performance.

In the evaluation function at the broker end, in similar vein to the FMG end, individual brokers at a broker house are requested to rate FMGs under various qualities. Again, ratings from more senior employees may be given higher weightings.

In the brokers' analysis function, a similar interface to the FMG end is provided, and thus a broker may choose to analyze a single FMG firm's “performance”, or a group of firms, under the various qualities rated, with weighting as desired according to quality, sector or market. They may also choose to analyze other brokers' ratings of the FMGs, either alone, on average, or in comparison with the broker's own ratings.

Perhaps more useful in the analysis at the broker end, a broker house may analyze the ratings given to it (or other brokers) by an FMG (or group thereof) in order to assess its market performance. Thus, the ratings given for its performance by a particular FMG may be displayed, for example in a particular industry sector. Alternatively, the ratings given by a number of FMGs may be analyzed. This data may be particularly useful, as if compared with the general trend of the broker's performance under the various criteria, the needs of particular FMGs in comparison with others may be determined. For example, it may be clear from the results that one FMG is far more concerned with consistency of execution than it is with the quality of the morning news sheet. These results may, again, be weighted to concentrate on the perceived relative strengths, or weaknesses of the broker. In one embodiment, the broker is able to directly view the weightings defined by an FMG for the different qualities rated, or for different business segments, in order to determine the FMG's particular needs and priorities.

This data may also be compared with the amount of business being received from the FMGs, in order to better target any improvements which may be suggested by the above comparisons.

Similarly, at the FMG end, there is the possibility of analyzing broker reaction to their relationship. For example, a particular FMG will be able to display results from brokers showing whether they have a strong relationship, or whether they are regarded as inconsistent or unreliable.

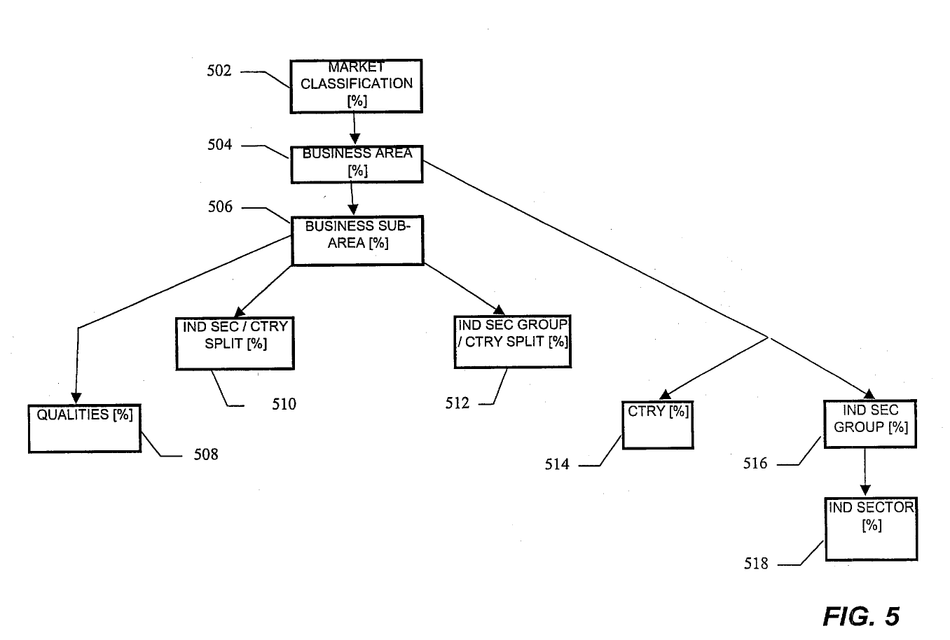

As previously mentioned, in some embodiments a system of weightings is used by the various analysis functions in order to modify the results according to the user's perceived relative importance of various types of broker services in particular business segments. For example, services received in one industry sector may be considered of greater importance than those in another sector, and weightings for the sectors may be chosen and applied to the ratings data accordingly. An example of a hierarchy of weightings is shown in FIG. 5.

In this example, weightings are defined for a variety of categories and subcategories of ratings data. Specifically, individual weightings may be defined by a user for each market classification (502), each broker business area (504) within a given market classification and each broker business sub-area (506) within a given business area. Within a business area (504), each country (514) and each industry sector (518) may be weighted. In the special case of the “trading” business area, an additional level is provided in the hierarchy in the form of industry sector groups (516), which may also be weighted. For each business sub-area (506), the user can specify the split (again as a relative weighting) between industry sector and country related ratings (510), or alternatively, in the special case of the “trading” business area, the split between industry sector group and country related ratings (512). The relative importance of the various qualities (508) within each business sub-area may also be defined.

Weightings are expressed as percentages, such that the total weightings in each weighted category add up to 100%.

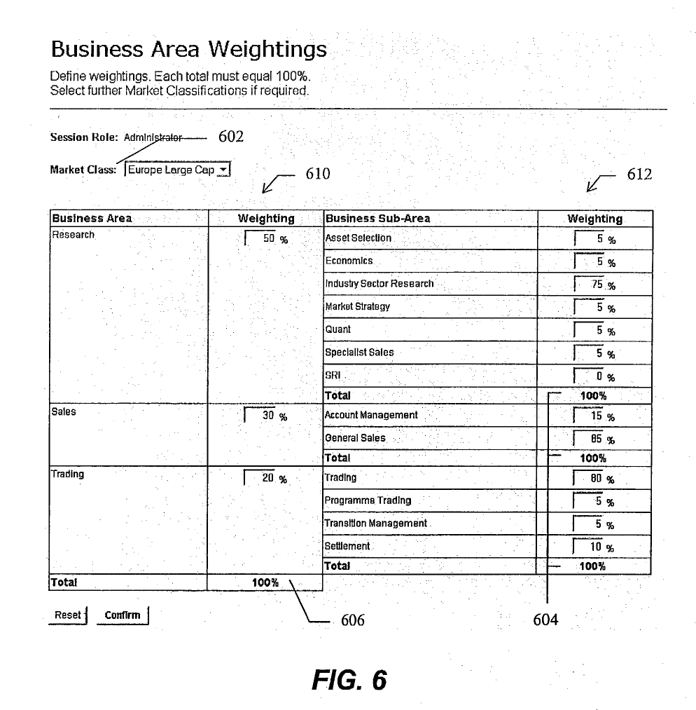

An example of a user interface screen for defining weightings is shown in FIG. 6. In the screen shown, the user selects the required market classification (602), following which the stored weightings (610, 612) for each business area within that market classification, and each business sub-area within those business areas, are displayed, along with business area and market classification totals (604, 606). The user may then change the weightings and submit the changes using the “confirm” button. Before the modified weightings are stored, the user interface checks whether the business sub-area and business area weightings add up to 100%, and displays an error message if they do not.

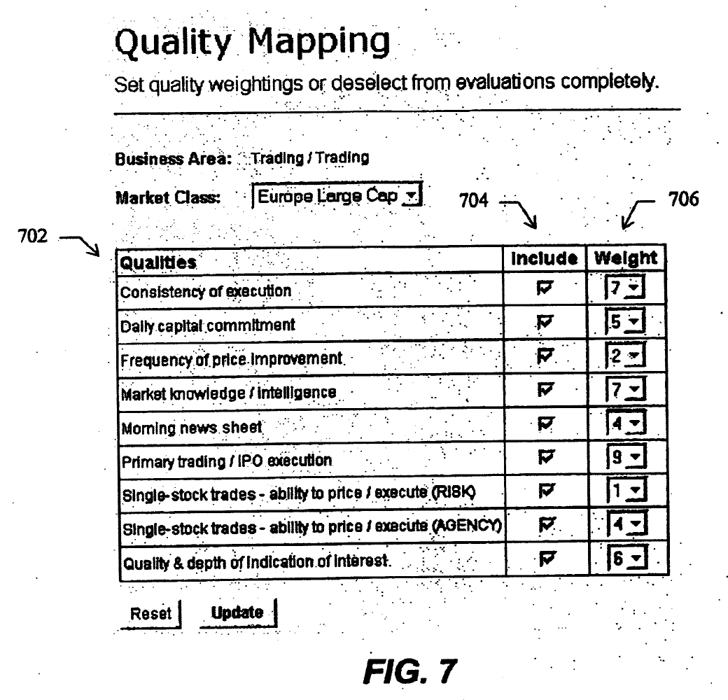

FIG. 7 gives an example of a user interface screen allowing weightings (706) to be defined for the various qualities (702) under which brokers are rated. In this example, weightings (706) are entered as absolute numbers instead of percentages. Equivalent percentage weightings are calculated by the system when applying the weightings, for example during analysis. The user may also exclude certain qualities from the analysis entirely by unchecking the relevant one of the checkboxes (704).

Similar screens are used to set the other weightings in the weightings hierarchy. In addition to the weightings discussed above, further aspects may also be weighted. For example, as indicated above, a weighting may be defined for each user of the rating system, for example, to assign higher importance to weightings entered by more senior/experienced users.

During evaluation, aggregations can be performed according to the stored weightings. For example, to provide a user rating summarizing all ratings given by a given user for a given broker in a given industry sector, the user's ratings of the individual qualities may be combined using the quality weightings (706) entered in the screen of FIG. 7, which define the relative importance of each quality. The resulting user rating may then be combined with other users' ratings in accordance with a weighting defined for each user (for example representing his level of experience) to provide a weighted aggregate rating for the given broker in the given industry sector in which the relative importance of the different qualities and the relative experience of the users who provided the ratings are taken into account.

In a further example, a weighted aggregate business area rating may be generated from business sub-area ratings and weightings. It is also possible to generate a single score for each broker from all the ratings data supplied—across all users, markets, business (sub-)areas and industry sectors—by applying all weightings in the weightings hierarchy to the ratings data.

Alternatively, weightings may be applied without aggregation. For example, the ratings for each business sub-area can be multiplied by their relevant weightings, with the resulting weighted sub-area ratings then being presented without aggregation to enable comparison between the sub-areas.

The system provides default weightings in the case where no weightings have been defined by a user (for example, to give equal weight to the members of each category). Weightings are typically set by a senior user, such as a manager.

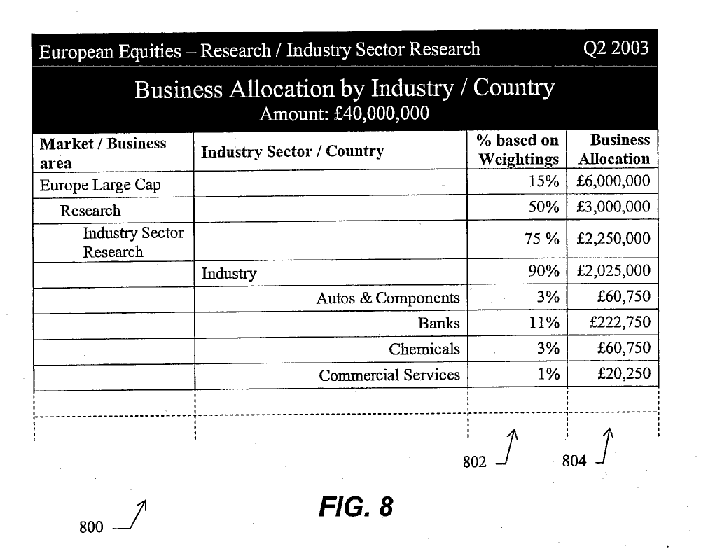

Since the weightings express the relative (perceived) importance of different categories of ratings—for example the relative importance of different industry sectors within a business area—the weightings may be used to supply useful information even when not applied to ratings data. An example of this is shown in FIG. 8, which shows an extract (800) of an example report generated by the system. Here, the weightings are used to calculate a suggested allocation of business to various market classifications, business areas and sub-areas and industry sectors. This is achieved by distributing an amount of money which is to be allocated amongst the different categories based on the weightings. In the example shown, the amount of money to be allocated is £40,000,000. The stored weightings for the various categories are shown in the “% based on weightings” column (802). By multiplying the weighting with the amount available for a given category, an allocation for that category can be determined. This allocation can in turn be used with sub-category weightings to determine sub-category allocations. Allocations are shown in the “Business Allocation” column (804). In the example shown, a sum of £2,250,000 is allocated to business sub-area “Industry Sector Research”, that figure being 75% (the sub-area's weighting) of the “Research” business area's allocation of £3,000,000.

In this way, apart from the primary aim of the system in providing an assessment of services, the hierarchy of weightings defined can also be used as a planning tool. In a further example of this, the actual ratings given to various brokers may be used, in conjunction with the system of weightings, to generate a proposed distribution of funds to those brokers.

Furthermore, external data may be imported and analyzed in conjunction with the ratings data (optionally in accordance with the defined weightings). Examples of external data include ratings data recorded at previous times (for example, in a previous quarter), actual transaction figures/sales volumes and benchmark data.

A specific example of an assessment system for a broker/FMG relationship has been described above. However, similar assessment systems may be devised for a large variety of other types of relationships. For example, a similar assessment system could be used by companies (and employees of those companies) to assess the legal services provided by law firms, rating each firm on a variety of qualities, for example quality of advice, timeliness and cost of services. Furthermore, separate ratings may be provided for different service sectors, such as different types of legal services provided by each firm, with the different types of services weighted based on relative importance. In any given domain, a suitable hierarchy of service sectors and sub-sectors may be defined (similar to the market classification, business area, sub-area and industry sector hierarchy discussed above), along with a corresponding weighting hierarchy. Other examples of relationships in which such an assessment system could be implemented include pension funds and FMGs, companies and consultancies, recruiters and recruitment agencies and manufacturers and component suppliers.

Apart from the obvious advantages gained, and those already mentioned, from such a system of performance assessment, there are various more subtle advantages which arise with use of the invention, in its various embodiments.

The costs of building up such assessment systems will doubtless be far from trivial, but may be greatly reduced by the use of a central standard by the groups involved on either side of the business relationship. This would save each individual company from the expense of devising a proprietary system, and would also be more efficient, as the assessment systems would be intended to work together, rather than being forced to do so after-the-fact. Also, by providing a standardized rating scheme to participating companies, such an assessment system can enable more reliable benchmarking of one company against its peers.

Furthermore, such an assessment system can be a useful planning tool, since it can be used not only in assessing services provided by service providers, but also in allocating business to those service providers and to different service sectors, optionally in dependence on the results of the assessment.

The introduction of such an assessment system into almost any similar business relationship would likely have the almost immediate benefit of increasing competition between companies on either side of the relationship, thus promoting efficiency, and ultimately providing greater value for money for any consumer involved.

In the specific example of the broker/FMG relationship, there is particular advantage in the recordal of the data solicited and analyzed by both parties. Various recent reports and standards (for example, the Myners report and the AIMR trading guidelines) require that each party behave in a particular fashion in conducting these types of transaction, and that certain data be recorded. The present invention will promote the use of standard protocol in these procedures, and also as a secondary effect provide a record of transactions between the companies involved.

It will be appreciated by those skilled in the art that the invention has been described by way of example only, and a wide variety of alternative approaches may be adopted.

We claim:

1. A computer-implemented method of processing data for evaluating service providers, comprising the steps of:
providing a qualitative rating scale for each of a plurality of service actions performed by the service providers;
receiving data from a user in the form of subjective scores on the rating scale for each service action, for each service provider;
processing the data to compare ratings scores for service actions of a specific service provider with ratings scores of other service providers for those service actions; and
collating the ratings score comparisons to provide an evaluation of the specific service provider's comparative performance.

2. A method according to claim 1, comprising providing rating scales for each provider's performance of the service actions over a plurality of service sectors.

3. A method according to claim 1, wherein the user comprises a plurality of independent sub-users, and comprising receiving independently subjective scores from each sub-user.

4. A method according to claim 3, comprising aggregating the sub-users' scores to provide overall user scores.

5. A method according to claim 4, comprising: receiving for each sub-user an expertise value; and weighting a specific sub-user's contribution to the overall user score according to their received expertise value.

6. A method according to claim 4, further comprising receiving an indication of approval of a sub-user's scores, and wherein aggregating the sub-users' scores comprises aggregating only approved sub-users' scores.

7. A method according to claim 1, wherein the steps of processing data to compare scores and collating the comparisons comprise receiving importance values for each of the service actions, and weighting the scores associated with different service actions, according to the received importance values.

8. A method according to claim 1, wherein each subjective score received from the user is associated with one of a plurality of service sectors, and wherein the steps of processing data to compare scores and collating the comparisons comprise receiving importance values for each of the plurality of service sectors, and weighting the scores associated with different service sectors, according to the received importance values.

9. A method according to claim 8, further comprising calculating an apportionment of given resource between the plurality of service sectors in dependence on at least one of: the received importance values and the scores.

10. A method according to claim 8, further comprising calculating an apportionment of given resource between the service providers in dependence on at least one of: the received importance values and the scores.

11. A method according to claim 1, comprising recording the ratings and comparisons according to an independently applied standard.

12. A method according to claim 3, wherein the service providers comprise equity brokers, the user comprises a fund management group and the sub-users comprise traders employed by the fund management group.

13. A method according to claim 1, comprising reporting the evaluation of the specific service provider's performance to that service provider.

14. A method according to claim 1, further comprising the steps of:
receiving further data from further users in the form of subjective scores on the rating scale for each service action, for each service provider;
receiving from the user a peer group selection comprising a selection of a set of the further users; and
processing the data and the further data to compare ratings scores received from the user with ratings scores received from users in the peer group.

15. A method according to claim 1, comprising importing objective data, and comparing the objective data with the subjective rating scores data.

16. A collaborative computer-implemented method of processing data for evaluating service providers, comprising the steps of:
providing to each of a group of users a common qualitative rating scale for each of a plurality of service actions performed by the service providers;
receiving data from each user in the form of subjective scores on the rating scale for each service action, for each service provider;
processing the data to compare ratings scores for service actions of a specific service provider with ratings scores of other service providers for those service actions;
collating the ratings score comparisons to provide an evaluation of the specific service provider's comparative performance;
and providing a representation of such evaluation to each user.

17. A method according to claim 16, further comprising the steps of:
receiving from one of the group of users a peer group selection specifying a selection of users from the group of users; and
processing the data to compare ratings scores received from said one user with ratings scores received from users in the peer group.

18. A computer-implemented method of processing data for assessing the requirements of a specific user for a service to be provided, comprising the steps of:
providing a qualitative rating scale for each of a plurality of service actions provided;
receiving data from a plurality of independent users in the form of independently subjective scores on the rating scale for each service action;
processing the data to compare the distribution of ratings scores over the plurality of service actions from the specific user with the distribution of scores over the service actions from other users; and
recording those service actions for which for the specific user the distribution varies significantly relative to the distribution for other users.

19. A method according to claim 18, comprising importing objective data, and comparing the objective data with the subjective rating scores data.

20. A software computer program recorded on any removable medium and adapted to cause a computer to implement a method according to claim 1.

21. A software computer program recorded on any removable medium and adapted to cause a computer to implement a method according to claim 16.

22. A software computer program recorded on any removable medium and adapted to cause a computer to implement a method according to claim 18.

23. A computer system programmed to perform a method according to claim 1.

24. A computer system programmed to perform a method according to claim 16.

25. A computer system programmed to perform a method according to claim 18.

26. A computer network and network protocol established between service providers and users and adapted to provide a method according to claim 1.

27. A computer network and network protocol established between service providers and users and adapted to provide a method according to claim 16.

28. A computer network and network protocol established between service providers and users and adapted to provide a method according to claim 18.

29. A data processing system for providing performance evaluation of a plurality of service providers to a plurality of service users, comprising:
in a service user domain, data processing sites for each of the plurality of service users, and means for providing a qualitative rating scale for each of a plurality of service actions performed by the service providers, to each of the plurality of service users' processing sites;
a central server for receiving data from user sites in the form of subjective scores on the rating scale for each service action and for each service provider, processing the data to compare ratings scores for service providers, and collating the ratings score comparisons to provide evaluation of the service providers' comparative performance; and
means for communication of data between the central server and the user domain.

30. A system according to claim 29, comprising means for providing rating scales for each provider's performance of the service actions over a plurality of service sectors.

31. A system according to claim 29, wherein each service user comprises a plurality of independent sub-users, and wherein the central server is adapted to receive independently subjective scores from each sub-user.

32. A system according to claim 31, wherein the central server is adapted to aggregate the sub-users' scores to provide overall user scores.

33. A system according to claim 32, wherein the central server is adapted to receive for each sub-user an expertise value; and weight a specific sub-user's contribution to the overall user score according to their received expertise value.

34. A system according to claim 32, wherein the central server is adapted to receive an indication of approval of a sub-user's scores, and to aggregate only approved sub-users' scores.

35. A system according to claim 29, wherein the central server is adapted to receive importance values for each of the service actions, and weight the scores associated with different service actions, according to the received importance values.

36. A system according to claim 29, wherein each subjective score is associated with one of a plurality of service sectors, and wherein the central server is adapted to receive importance values for each of the service sectors, and weight the scores associated with different service sectors, according to the received importance values.

37. A system according to claim 36, wherein the central server is adapted to calculate an apportionment of given resource between the plurality of service sectors in dependence on at least one of: the received importance values and the scores.

38. A system according to claim 36, wherein the central server is adapted to calculate an apportionment of given resource between the plurality of service providers in dependence on at least one of: the received importance values and the scores.

39. A system according to claim 29, wherein the central server is adapted to record the ratings and comparisons according to an independently applied standard.

40. A system according to claim 31, wherein the service providers comprise equity brokers, the users comprise fund management groups and the sub-users comprise traders employed by each fund management group.

41. A system according to claim 29, wherein the central server is adapted to report the evaluation of the specific service provider's performance to that service provider.

42. A system according to claim 29, wherein the central server is adapted to process the data to compare the distribution of ratings scores over the plurality of service actions from the specific user with the distribution of scores over the service actions from other users; and record those service actions for which for the specific user the distribution varies significantly relative to the distribution for other users.

43. A system according to claim 29, wherein the central server is adapted to receive from one of the plurality of users a peer group selection specifying a selection of users from the plurality of users, and process the data to compare ratings scores received from said one user with ratings scores received from users in the peer group.

44. A data processing system for providing performance evaluation of a plurality of service providers, comprising:
a service weighting interface providing a hierarchy of service actions to be performed by the service providers in a plurality of service categories and enabling entry by a user of relative weighting values for service actions in each service category and for each category;
a service weighting display serving to display a normalized representation of said user entered weighting values indicating the apportionment of given resource between service categories in accordance with said user entered weighting values;
a service assessment interface providing a hierarchy of service actions to be performed by the service providers in a plurality of service categories and enabling entry by a user of subjective scores on the rating scale for each service action and for each service provider;
a processor for receiving data in the form of subjective scores on the rating scale for each service action and for each service provider, applying said weightings to said data, and processing the weighted data to compare ratings scores for service providers; and
a service provider assessment display indicating comparative ratings scores for respective service providers according to respective service categories.

45. A system according to claim 44, wherein the plurality of service categories are structured in a service category hierarchy comprising at least two hierarchical levels, each hierarchical level having associated with it a set of weighting values, the set comprising a weighting value for each category within that hierarchical level.

46. A system according to claim 44, further comprising a resource allocation display serving to display the apportionment of given resource between service categories in accordance with said user entered weighting values.

47. A system according to claim 44, further comprising a resource allocation display serving to display the apportionment of given resource between service providers in accordance with at least one of: said user entered weighting values and said ratings scores.
